(19) United States
(12) Patent Application Publication
(10) Pub. No.: US 2020/0108574 A1
(43) Pub. Date: Apr. 9, 2020

(54) TIRE

(71) Applicant: Toyo Tire Corporation, Itami-shi (JP)

(72) Inventor: Masashi NAKAMURA, Itami-shi (JP)

(73) Assignee: Toyo Tire Corporation, Itami-shi (JP)

(21) Appl. No.: 16/587,341

(22) Filed: Sep. 30, 2019

(30) Foreign Application Priority Data
Oct. 3, 2018 (JP) 2018-188138

(51) Int. Cl. B29D 30/00; H01Q 1/22

(52) U.S. Cl. CPC B29D 30/0061; G06K 19/07764; B29D 2030/0083; H01Q 1/2241

(57) ABSTRACT

A tire includes: a bead core, and a bead filler having a first bead filler covering an outer circumference of the bead core and a second bead filler arranged at an outer side in the tire-radial direction of the first bead filler, in which an electronic component is embedded at an interface between the first bead filler and second bead filler, and more to an inner side in the tire-width direction than a center line of the bead filler, in a cross-sectional view including the central axis of the tire.

### CROSS-REFERENCE TO RELATED APPLICATIONS

This application is based on and claims the benefit of priority from Japanese Patent Application No. 2018-188138, filed on 3 Oct. 2018, the content of which is incorporated herein by reference.

### FIELD

The present invention relates to a tire in which an electronic component is embedded.

### BACKGROUND

Conventionally, tires in which an electric component such as an RFID tag is embedded have been known. By an RFID tag embedded in the tire and a reader as an external device carrying out communication, it is possible to perform production management of tires, usage history management, etc. For example, Japanese Unexamined Patent Application, Publication No. 2016-37236 discloses a tire in which an RF tag is embedded in the vicinity of a stiffener.

### SUMMARY

However, in the technology shown in Patent Document 1, the RF tag is arranged between the stiffener and side rubber, and a fiber layer such as that of a carcass ply does not exist between the RF tag and the tire outer wall. Consequently, in the case of the tire greatly distorting, or a case of shock acting on the tire, there is concern over the RF tag not being protected and thus being damaged.

In addition, with the technology illustrated in Patent Document 1, the RF tag is arranged in the vicinity of a stiffener adjacent to a metal bead core. Consequently, the communication state of an electronic device such as the RF tag having a communication function is influenced by the bead core made of metal and becomes unstable, and there is a possibility of no longer being able to exhibit the function of the electronic component itself.

The present invention has been made taking account of the above-mentioned problem, and an object thereof is to provide a tire which can protect an electronic component, in a case of the tire greatly distorting, or a case of shock acting on the tire, and can maintain the performance of the electronic component.

A tire (for example, the tire 1) according to a first aspect of the present invention includes: a bead core (for example, the bead core 21); and a bead filler (for example, the bead filler 22) having a first bead filler (for example, the first bead filler 221) covering an outer circumference of the bead core and a second bead filler (for example, the second bead filler 22) disposed at an outer side in a tire-radial direction of the first bead filler, in which an electronic component (for example, the RFID tag 40) is embedded at an interface (for example, the interface 22B) between the first bead filler and the second bead filler, and more to an inner side in a tire-width direction than a center line (for example, the center line S) of the bead filler, in a cross-sectional view including a central axis of the tire.

According to a second aspect of the present invention, the tire as described in the first aspect may further include: a carcass ply (for example, the carcass ply 23) having a ply body (for example, the ply body 24) extending between a tread (for example, the tread 12) of the tire and a bead (for example, the bead 11) having the bead core and the bead filler, and a ply folding part (for example, the ply folding part 25) which is folded back around the bead core,

According to the present invention, it becomes possible to provide a tire which can protect an electronic component, in a case of the tire greatly distorting, or a case of shock acting on the tire, and can maintain the durability and favorable communication performance of the electronic component.

### BRIEF DESCRIPTION OF THE DRAWINGS

FIG. 1 is a view showing a half section in a tire-width direction of a tire according to an embodiment of the present invention;

FIG. 2 is a partially enlarged cross-sectional view of the tire in FIG. 1;

FIG. 3A is a view showing an RFID tag which is protected by a protective member in the tire according to the embodiment of the present invention;

FIG. 3B is a view showing a cross section along the line b-b in FIG. 3A;

FIG. 3C is a view showing a cross section along the line c-c in FIG. 3A; and

FIG. 4 is a partially enlarged cross-sectional view of a tire showing a modified example of the tire according to the embodiment of the present invention.

### DETAILED DESCRIPTION

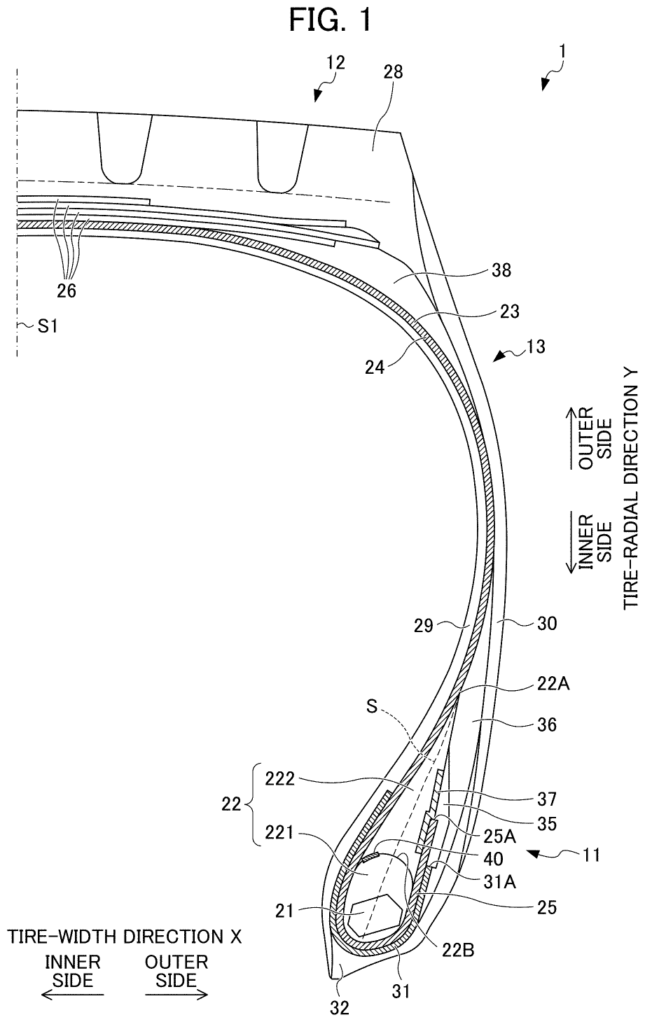

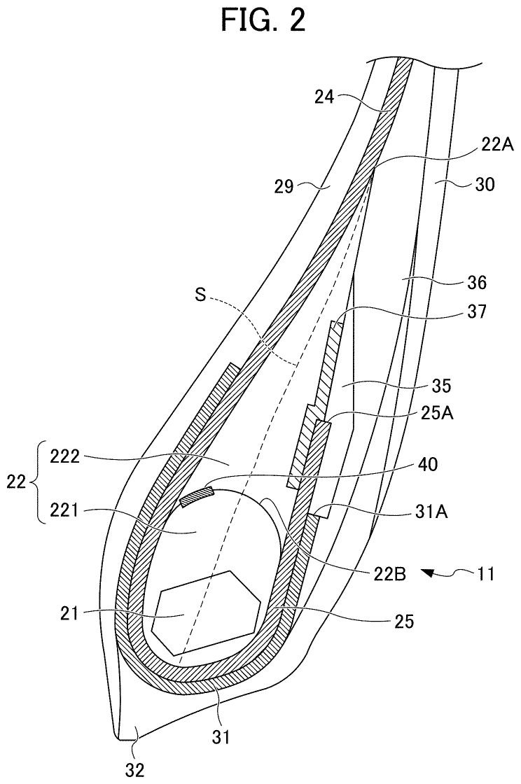

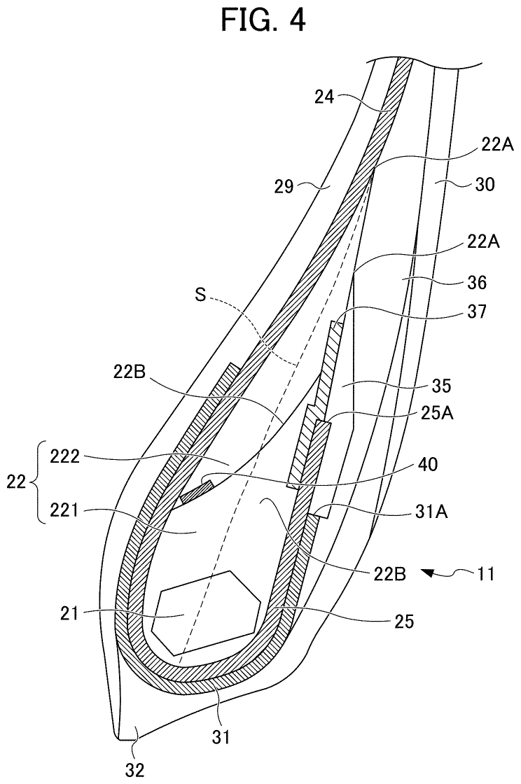

Hereinafter, an embodiment of the present invention will be explained while referencing the drawings. FIG. 1 is a view showing a half section in a tire-width direction of a tire 1 according to the present embodiment. The basic structure of the tire is left/right symmetric in the cross section of the tire-width direction; therefore, a cross-sectional view of the right half is shown herein. In the drawings, the reference symbol S1 is the tire equatorial plane. The tire equatorial plane S1 is a plane orthogonal to the tire rotation axis, and is positioned in the center of the tire-width direction. Herein, tire-width direction is a direction parallel to the tire rotation axis, and is the left/right direction of the paper plane of the cross-sectional view in FIG. 1. In FIG. 1, it is illustrated as the tire-width direction X. Then, inner-side of tire-width direction is a direction approaching the tire equatorial plane S1, and is the left side of the paper plane in FIG. 1. Outer side of tire-width direction is a direction distancing from the tire equatorial plane S1, and is the right side of the paper plane in FIG. 1. In addition, tire-radial direction is a direction perpendicular to the tire rotation axis, and is the vertical direction in the paper plane of FIG. 1. In FIG. 1, it is illustrated as the tire-radial direction Y. Then, outer-side of tire-radial direction is a direction distancing from the tire rotation axis, and is the upper side of the paper plane in FIG. 1. Inner-side of tire-radial direction is a direction approaching the tire rotation axis, and is the lower side of the paper plane in FIG. 1. The same also applies to FIGS. 2 and 4.

The tire 1 is a tire for heavy loads used in trucks and buses, for example, and as shown in FIG. 1, includes a pair of beads 11 provided at both sides in the tire width direction, tread 12 forming a contact patch with the road surface, and a pair of sidewalls 13 which extends between the pair of beads and the tread 12.

The bead 11 includes an annular bead core 21 formed by wrapping around several times bead wires made of metal coated with rubber, and a bead filler 22 of tapered shape extending to the outer side in the tire-radial direction of the bead core 21. The bead filler 22 is configured by a first bead filler 221 which covers the outer circumference of the bead core 21, and a second bead filler 222 which is arranged on the outer side in the tire-radial direction of the first bead filler 221.

The second bead filler 222 is configured from rubber with a modulus higher than an inner liner 29 and side wall rubber 30 described later. Then, the first bead filler 221 is configured from rubber of an even higher modulus than the second bead filler 222. It should be noted that the first bead filler 221 may be a form not covering the outer circumference of the bead core 21, if at least a part thereof is arranged on the outer side in the tire-radial direction of the bead core 21. In addition, the bead filler 22 may be formed from rubber of one type. In other words, it may not necessarily be divided into the first bead filler 221 and second bead filler 222.

The bead core 21 is a member which plays a role of fixing a tire filled with air to the rim of a wheel which is not illustrated. The bead filler 22 is a member provided in order to raise the rigidity of the bead peripheral part and to ensure high maneuverability and stability.

A carcass ply 23 constituting a ply serving as the skeleton of the tire is embedded inside of the tire 1. The carcass ply 23 extends from one bead core to the other bead core. In other words, it is embedded in the tire 1 between the pair of bead cores 21, in a form passing through the pair of side walls 13 and the tread 12.

The carcass ply 23 includes a ply body 24 which extends from one bead core to the other bead core, and extends between the tread 12 and bead 11, and a ply folding part 25 which is folded around the bead core 21. Herein, a folding end 25A of the ply folding part 25 is positioned more to an inner side in the tire-radial direction than a tire-radial direction outside end 22A of the bead filler 22.

The carcass ply 23 is configured by a plurality of ply cords extending in a tire-width direction. In addition, a plurality of ply cords is arranged side by side in a tire circumferential direction. This ply cord is configured by a metal steel cord, or an insulated organic fiber cord such as polyester or polyamide, or the like, and is covered by rubber.

In the tread 12, a plurality of layers of steel belts 26 is provided in the outer side in the tire radial direction of the carcass ply 23. The steel belt 26 is configured by a plurality of steel cords covered by rubber. By providing the steel belts 26, the rigidity of the tire is ensured, and the contact state of the road surface with the tread 12 improves. In the present embodiment, although four layers of steel belts 26 are provided, the number of layered steel belt 26 is not limited thereto.

The tread rubber 28 is provided at the outer side in the tire-radial direction of the steel belt 26. A tread pattern is provided to the outer surface of the tread rubber 28, and this outer surface serves as a contact surface which contacts with the road surface.

In the vicinity of the outer side in the tire-width direction of the tread 12, in a region between the carcass ply 23, and the steel belts 26/tread rubber 28, a shoulder pad 38 is provided. This shoulder pad 38 extends until a region of the outer side in the tire-radial direction of the side wall 13, and part thereof forms an interface between side wall rubber 30 described later. In other words, in the region of the outer side in the tire radial direction of the side wall 13, a part of the shoulder pad 38 is present on the inner side in the tire width direction of the side wall rubber 30.

The shoulder pad 38 consists of a rubber member having cushioning, and exhibits a cushion function between the carcass ply 23 and steel belt 26. In addition, since the shoulder pad 38 consists of rubber having a characteristic of low heat buildup, it is possible to suppress heat generation effectively, by extending until the side wall 13.

In the bead 11, side wall 13 and tread 12, an inner liner 29 serving as a rubber layer constituting an inside wall surface of the tire 1 is provided to a tire inner cavity side of the carcass ply 23. The inner liner 29 is configured by air permeation resistant rubber, whereby the air inside the tire inner cavity is prevented from leaking to outside.

In the side wall 13, the side wall rubber 30 constituting the outer wall surface of the tire 1 is provided to the outer side in the tire-width direction of the carcass ply 23. This side wall rubber 30 is a portion which bends the most upon the tire exhibiting a cushioning action, and usually flexible rubber having fatigue resistance is adopted therein.

On the inner side in the tire radial direction of the carcass ply 23 provided around the bead core 21 of the bead 11, a steel chafer 31 serving as a reinforcement ply is provided so as to cover the carcass ply 23. The steel chafer 31 also extends to the outer side in the tire-width direction of the ply folding part 25 of the carcass ply 23, and an end part 31A of this steel chafer 31 is positioned more to the inner side in the tire-width direction than the folding end 25A of the ply folding part 25. This steel chafer 31 is a metal reinforcement layer configured by metal steel cords, and is covered by rubber.

Rim strip rubber 32 is provided at the inner side in the tire-radial direction of the steel chafer 31. This rim strip rubber 32 is arranged along the outer surface of the tire, and connects with the side wall rubber 30. This rim strip rubber 32 and side wall rubber 30 are rubber members constituting the outer surface of the tire.

Then, at the outer side in the tire-radial direction of the end part 31A of the steel chafer 31, which is at the outer side in the tire-width direction of the folding part 25 of the carcass ply 23 and bead filler 22, a first pad 35 is provided. This first pad 35 is provided so as to cover the outer side in the tire-width direction of at least the folding end 25A of the ply folding part 25. The outer side in the tire-radial direction of the first pad 35 is formed so as to taper as approaching the outer side in the tire-radial direction.

Furthermore, a second pad 36 is provided so as to cover the outer side in the tire-width direction of the first pad 35. In more detail, the second pad 36 is provided so as to cover the outer side in the tire-width direction of part of the steel chafer 31, the first pad 35, part of the second bead filler 222, and part of the ply body 24 of the carcass ply 23. In other words, the second pad 36 is provided between the first pad 35, etc., and the rim strip rubber 32 and side wall rubber 30, which are members constituting the outer surface of the tire.

Herein, the first pad 35 and second pad 36 are configured by rubber of higher modulus than the modulus of the bead filler (second bead filler 222) to which these members contact. In more detail, the second pad 36 is configured by rubber of higher modulus than the second bead filler 222, and the first pad 35 is configured by rubber of even higher modulus than the second pad 36. The first pad 35 and second pad 36 have a function of mitigating sudden distortion caused by the local rigidity point of change at the folding end 25A of the carcass ply 23 and the end part 31A of the steel chafer 31.

At the inner side in the tire-width direction of the first pad 35, a rubber sheet 37 is arranged in the vicinity of the folding end 25A of the ply folding part 25. The rubber sheet 37 is arranged so as to cover at least the folding end 25A of the ply folding part 25 from the inner side in the tire-width direction.

Generally, at the folding end 25A of the ply folding part 25, stress tends to concentrate. However, by providing the aforementioned first pad 35 and second pad 36, and further arranging the rubber sheet 37, it becomes possible to effective suppress the concentration of stress.

Herein, the RFID tag 40 is embedded as an electronic component in the tire 1 of the present embodiment, as shown in FIGS. 1 and 2.

The RFID tag 40 is a passive transponder equipped with an RFID chip and an antenna for performing communication with external equipment, and performs wireless communication with a reader (not illustrated) serving as the external equipment. As the antenna, a coil-shaped spring antenna, plate-shaped antenna, and various types of rod-shaped antennas can be used. For example, it may be an antenna formed by printing a predetermined pattern on a flexible substrate. The antenna is established at an antenna length optimized according to the frequency band, etc. to be used. In a storage part inside the RFID chip, identification information such as a manufacturing number and part number is stored.

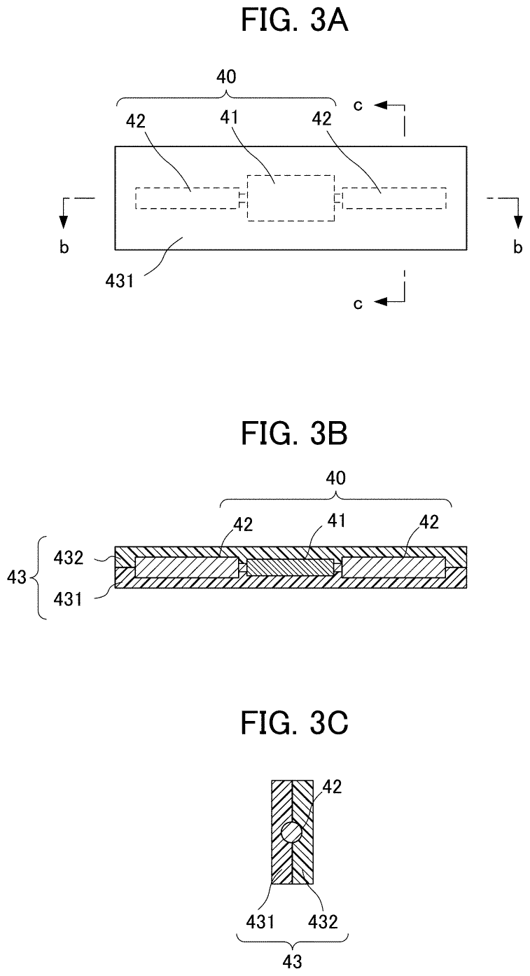

More specifically, FIG. 3A is a view showing an example of the RFID tag 40 of the present embodiment, covered by the protective member 43 configured from a rubber sheet. In FIG. 3A, the RFID tag 40 is covered and hidden by the rubber sheet 431 described later. FIG. 3B is a cross-sectional view along the line b-b in FIG. 3A, and FIG. 3C is a cross-sectional view along the line c-c in FIG. 3A.

In the present embodiment, as shown in FIG. 3A to 3C, the RFID tag 40 is covered by the protective member 43.

The RFID tag 40 includes an RFID chip 41 and antenna 42 for performing communication with external equipment. As the antenna 42, a coil-shaped spring antenna, plate-shaped antenna, and various types of rod-shaped antennas can be used. For example, it may be an antenna formed by printing a predetermined pattern on a flexible substrate. When considering the communicability and flexibility, a coil-shaped spring antenna is the most preferable.

The protective member 43 is configured from two rubber sheets 431, 432 which protect by sandwiching the RFID tag 40.

The protective member 43 is configured by rubber of a predetermined modulus, for example. Herein, the modulus indicates 100% elongation modulus (M100) under a 23° C. atmosphere, measured in accordance with “3.7 stress at a given elongation, S” of JIS K6251:2010.

As the rubber adopted in the protective member 43, rubber at least having a higher modulus than the side wall rubber 30 is used.

For example, rubber of a modulus of the same degree as the modulus of the second bead filler 222 may be used as the rubber for the protective member 43. It is thereby possible to prevent excessive stress from generating inside the rubber structure at the embedded part of the RFID tag 40, upon the tire deforming.

For example, with the modulus of the side wall rubber 30 as a reference, as the rubber used in the protective member 43, it is preferable to use rubber of a modulus 1.1 to 1.8 times.

In addition, the protective member 43 may be configured from a short-fiber filler mixed rubber. As the short-fiber filler, for example, it is possible to use insulating short fibers like organic short fibers such as aramid short fibers and cellulose short fibers; inorganic short fibers such as ceramic short fibers as in alumina short fiber, and glass short fiber. By mixing such short-fiber fillers into rubber, it is possible to raise the strength of the rubber. In addition, as the protective member 43, a rubber sheet in the vulcanized state may be used. The rubber sheet in a vulcanized state does not plastically deform as raw rubber, and thus can appropriately protect the RFID tag 40. In addition, as the protective member 43, an organic fiber layer from polyester fibers or polyamide fibers may be provided. It is also possible to embed an organic fiber layer in the two rubber sheets 431, 432.

In this way, if configuring the protective member 43 by two rubber sheets, since it is possible to thinly form the RFID tag 40 including the protective member 43, it is favorable upon embedding in the tire 1. In addition, when assembling the RFID tag 40 in the constitutional members of the tire 1 prior to vulcanization, the RFID tag 40 covered by the rubber sheets can be installed very easily. For example, at a desired position of a member such as the first bead filler 221 and second bead filler 222 prior to vulcanization, it is possible to appropriately paste the RFID tag 40 covered by the rubber sheets using the adhesiveness of the raw rubber. In addition, by also establishing the rubber sheets as raw rubber prior to vulcanization, it is possible to more easily paste by employing the adhesiveness of the rubber sheet itself as well. However, the protective member 43 is not limited to the form configured by two rubber sheets, and can adopt various forms. For example, at least one rubber sheet constituting the protective member, so long as covering at least part of the RFID tag 40, can obtain effects such as an improvement in workability in the manufacturing process and stress mitigation. In addition, for example, it may be a configuration wrapping one rubber sheet around the entire circumference of the RFID tag 40, or a configuration attaching the protective member in the form of a potting agent of high viscosity along the entire circumference of the RFID tag 40. Even if such a configuration, it will be possible to appropriately protect the RFID tag 40.

Then, in the tire 1 of the present embodiment, the RFID tag 40 is embedded within the bead filler 22, as shown in FIGS. 1 and 2.

In addition, the RFID tag 40 is fixedly set at the interface 22B (on the interface 22B) between the first bead filler 221 and second bead filler 222.

Furthermore, the RFID tag 40 is fixedly set more to the inner side in the tire-radial direction than the center line S of the bead filler 22, in a cross-sectional view including a central axis of the tire shown in FIGS. 1 and 2. In addition, the RFID tag 40 is adjacent to the ply body 24 of the carcass ply 23.

Then, in the tire 1 of the present embodiment consisting of the above-mentioned configuration, first, by the RFID tag 40 being fixedly set at the interface 22B between the first bead filler 221 and second bead filler 222, it is possible to stick to the member interface during manufacture and easily position the RFID tag 40.

In addition, by fixedly setting the RFID tag 40 at the interface 22B of the first bead filler 221 having a relatively high modulus, there will be little deformation, and it is possible to raise the durability of the RFID tag 40. In addition thereto, by being fixedly set at the interface 22B of the second bead filler 222 having a lower modulus than the first bead filler 221, it is possible to absorb impact at the second bead filler 222.

Furthermore, by the RFID tag 40 being fixedly set more to the inner side in the tire-radial direction than the center line S of the bead filler 22 in a cross-sectional view, and by the RFID tag 40 being provided adjacent to the ply body 24 of the carcass ply 23, it is possible to separate from the side wall 13. Furthermore, it is possible to separate the RFID tag 40 from folding end 25A of the ply at which stress tends to concentrate and distortion tends to increase. Furthermore, displacement will hardly occur by the ply body 24 of the carcass ply 23. It thereby becomes possible to further improve the durability of the RFID tag 40.

It should be noted that, in the present embodiment, the RFID tag 40 is embedded in the tire 1 as the electronic component; however, the electronic component embedded in the tire 1 is not limited to the RFID tag 40. For example, it may be various electronic components such as a sensor which carries out wireless communication. In addition, since the electronic component handles electrical information such as sending and receiving of electrical signals, there is a possibility of the performance declining due to metal components being present in the vicinity thereof. In addition, there is a possibility of the electronic component being damaged by excessive stress acting thereon. Consequently, even in the case of embedding various electronic components in a tire 1, it is possible to obtain the effects of the present invention. For example, the electronic component may be a piezoelectric element or strain sensor.

In addition, the shape of the interface 22B between the first bead filler 221 and second bead filler 222 does not necessitate particular limitations, and the bead filler 22 may be formed and configured in an interface shape differing from the present embodiment, as shown in FIG. 4, for example.

According to the tire 1 of the present embodiment, the following effects are exerted.

(1) In the tire 1 according to the present embodiment, the RFID tag 40 is embedded at the interface 22B between the first bead filler 221 and second bead filler 222, and more to the inner side in the tire-width direction than the center line S of the bead filler 22, in a cross-sectional view including the central axis of the tire 1.

By the RFID tag 40 being fixedly set at the interface 22B between the first bead filler 221 and second bead filler 222 in this way, it is possible to stick at the member interface during manufacture and easily position the RFID tag 40, whereby it becomes possible to improve the process performance such as productivity and setting precision.

In addition, by fixedly setting the RFID tag 40 at the interface 22B of the first bead filler 221 having a relatively high modulus, there is little deformation, and it is possible to raise the durability of the RFID tag 40, and by fixedly setting at the interface 22B of the second bead filler 222 having a lower modulus than the first bead filler 221, it is possible to absorb impact by the second bead filler 222, whereby it is possible to raise the durability of the RFID tag 40.

Furthermore, by the RFID tag 40 being fixedly set more to an inner side in the tire-radial direction than the center line S of the bead filler 22 in a cross-sectional view, it is possible to separate from the side wall 13. In addition, it is possible to separate the RFID tag 40 from the folding end 25A of the ply at which stress tends to concentrate and distortion tends to increase. Displacement hardly occurs at the RFID tag 40, and it thereby becomes possible to further improve the durability of the RFID tag 40.

Furthermore, by the RFID tag 40 being provided adjacent to the ply body 24 of the carcass ply 23, the RFID tag 40 is protected by the carcass ply 23, and further, displacement will hardly occur at the RFID tag 40, whereby it becomes possible to further improve the durability of the RFID tag 40.

It should be noted that, although the tire of the present invention can be adopted as various types of tires such as for cars, light trucks, trucks and buses, it is particularly suitable as a tire of a truck, bus, etc. In other words, the present invention is not to be limited to the above-mentioned embodiments, and that even when carrying out modifications, improvements, etc. within a scope capable of achieving the object of the present invention, it is encompassed by the scope of the present invention.

What is claimed is:

1. A tire comprising: a bead core; and a bead filler having a first bead filler covering an outer circumference of the bead core and a second bead filler disposed at an outer side in a tire-radial direction of the first bead filler,
wherein an electronic component is embedded at an interface between the first bead filler and the second bead filler, Closer to an inner side in a tire-width direction than a center line of the bead filler, in a cross-sectional view including a central axis of the tire.

2. The tire according to claim 1, further comprising a carcass ply having a ply body extending between a tread of the tire and a bead having the bead core and the bead filler, and a ply folding part which is folded back around the bead core,
wherein the electronic component is adjacent to the ply body.
